(19) United States
(12) Patent Application Publication
(10) Pub. No.: US 2005/0260471 A1
(43) Pub. Date: Nov. 24, 2005

(54) Electrical current measurement in a fuel cell

(76) Inventors: Victor W. Logan, Naples, NY (US); Bruce J. Clingerman, Palmyra, NY (US); James W. Dandalides, Webster, NY (US); Scott B. Gonser, Big Bear City, CA (US)

Correspondence Address: General Motors Corporation;Legal Staff - Mail Code 482-C23-B21, 300 Renaissance Center, PO Box 300, Detroit, MI, 48265-3000, US

(21) Appl. No.: 11/099,261

(22) Filed: Apr. 5, 2005

Related U.S. Application Data
(60) Provisional application No. 60/572,031, filed on May 18, 2004.

(51) Int. Cl. H01M 8/04; H01M 8/24

(52) U.S. Cl. 429/23; 429/13

(57) ABSTRACT

A plurality of electrical current sensors for a set of fuel cell stacks in series independently measure electrical current in a fuel cell, and an acceptability status is determined for each electrical current sensor by independent comparison of each sensor measurement to the individual values of the other sensor measurements. A characteristic current measurement is derived from all electrical current sensors having an acceptability status which is trustworthy.

### CROSS-REFERENCE TO RELATED APPLICATIONS

This application claims the benefit of U.S. Provisional Application No. 60/572,031, filed on May 18, 2004, the disclosure of which is incorporated herein by reference.

### FIELD OF THE INVENTION

The present invention relates to fuel cell power systems and more particularly to methods for measuring electrical current generated by a fuel cell stack of the fuel cell power system.

### BACKGROUND OF THE INVENTION

Conventional fuel cell power systems convert a fuel and an oxidant to electricity in a fuel cell stack. A typical fuel cell stack includes a proton exchange membrane (“PEM”) with a catalytic anode layer and a catalytic cathode layer formed on opposite faces thereof. Reactant gases are directed across the catalytic faces to facilitate reaction of fuel (such as hydrogen) and oxidants (such as oxygen or air) in to electricity.

Effective operation of a fuel cell stack or set of fuel cell stacks requires measurement of electrical power generated from the individual cells in the fuel cell stack, a set or cluster of cells or a set of connected fuel cell stacks. In this regard, high power fuel cell systems (e.g., 200 kW) may use multiple fuel cell stacks to generate the necessary power requirements. A multiple fuel cell stack set may be a preferred approach to a single fuel cell stack arrangement having either a large active area or a substantial number of cells. Specifically with multiple fuel cell stacks, each fuel cell stack may be of relatively standard critical mass and size as optimized over many design instances and provided as an “off-the-shelf” fuel cell stack module which is readily extended in scope by a deployment in an electrical voltage and resistance series. As should be apparent, the current in each fuel cell stack in such an electrical series arrangement is equal for all fuel cell stacks in the series.

In a multiple series stack fuel cell system, it is desirable for system controls to respond to accurate measurement of the electrical current output from the fuel cell stacks. The most common method for measuring system electrical current is with Hall-effect sensor technology. When using multiple fuel cell stacks electrically in series, it is beneficial for each fuel cell stack assembly to have its own electrical current sensor to facilitate system diagnostics, operation switching control, and the like. When “off-the-shelf” fuel cell stack modules (as previously discussed) are combined to achieve higher total power levels, each module conveniently has its own electrical current sensor by design to function as a stand-alone module if deployed in that manner. Because the multiple stack system has multiple redundant electrical current sensors, it is advantageous to determine system electrical current by using the average of all electrical current sensors measuring electrical current from the set of fuel cell stacks connected in the voltage (and resistance) series so that one measurement, representative of the electrical current generated by the set of fuel cell stacks as a whole, is provided to the control process logic for use in manipulation (i.e., adjustment) decisions respective to control elements to the fuel cell system.

One disadvantage, however, in using such an averaged electrical current measurement directly is that such an approach does not account for failure in a particular electrical current sensor. In this regard, a common failure mode for a Hall-effect electrical current sensor is that significant drift will occur which is not readily detected using common sensor fault detection methods such as short circuit analysis, open wire detection, sensor out of range evaluation, and the like.

Another disadvantage derives from unnecessary shutdown of the fuel cell stack set if a single sensor failure halts the entire stack set in an otherwise unnecessary shutdown.

One solution to minimizing unnecessary shutdowns is to use high cost electrical current sensors which provide high reliability; however, the high cost aspect of such a solution is not desirable in minimizing the cost for a fuel cell system.

What is needed is a holistic approach to fuel cell operation which provides, acceptable measurement of electrical current, detection of failure electrical current sensors, compensation for failed electrical current sensors in maintaining robust operation of the fuel cell, and a basis for appropriate shutdown of the fuel cell stack and/or fuel cell stack set when electrical current measurements collectively indicate the need for such an operational event. The present invention is directed to fulfilling this need.

### SUMMARY OF THE INVENTION

The present invention provides a fuel cell using a plurality of electrical current sensors to independently measure electrical current generated by the membrane electrode assembly; a real-time computer connected to each electrical current sensor; and executable comparison logic in the computer for defining an acceptability status for each electrical current sensor by independent comparison of the value of the measurement of each electrical current sensor to the individual values of the measurements of each of the other electrical current sensors in the plurality of electrical current sensors.

The present invention also provides a method for operating a fuel cell which includes measuring electrical current generated by a fuel cell assembly with a plurality of electrical current sensors; defining an acceptability status for each electrical current sensor by computer-implemented independent comparison of the value of the measurement of each electrical current sensor to the individual values of the measurements of each of the other electrical current sensors in the plurality of electrical current sensors; and operating the fuel cell using measurements from electrical current sensors defined to have a trustworthy acceptability status.

The present invention also provides for use of a threshold tolerance variable (preferably with a fixed value) so that each acceptability status is defined by comparison of the difference of two independent electrical current sensor values to the tolerance variable.

The present invention further provides for an operation mode variable in the computer for designating invalid electrical current sensors.

The present invention further provides a fuel cell system using a set of fuel cell stacks electrically connected as a voltage and resistance in series where each stack has at least one electrical current sensor.

The present invention further provides a fuel cell system where a characteristic electrical current measurement is derived from all electrical current sensors having a trustworthy acceptability status and where the characteristic measurement is used to effect manipulation of control elements of the fuel cell, including the manipulation of control elements to shutdown operation of the fuel cell.

The present invention further provides a fuel cell system affecting a diagnostic communication (such as an enunciator) of the sensors determined to be untrustworthy. In a preferred implementation of the invention, the enunciator alerts an operator only if a sensor is determined to be untrustworthy (in a manner similar to an automotive ‘check engine’light).

The present invention may provide cost savings from the use of “low cost” electrical current sensors in a fuel cell system even though such “low cost” sensors have less rigorous accuracy and reliability attributes than “high cost” electrical current sensors; reliable fuel cell operation from combining electrical current measurements into a composite measurement for control; fuel cell system diagnostics; minimized shutdowns of otherwise trusted sensors and efficient fuel cell performance as drifting sensors are isolated and excluded from inducing inappropriate manipulations to fuel cell stack loading.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 presents a fuel cell power system block flow diagram;

FIG. 2 shows a fuel cell stack portion;

FIG. 3 shows a set of fuel cell stacks in an electrical series;

FIG. 4 shows a flowchart for determining electrical current sensor acceptability for a particular sensor;

FIG. 5 shows detail in the acceptability status definition of a set of electrical current sensors;

FIG. 6 shows detail in the agreement logical block of FIG. 5; and

FIG. 7 shows detail in the acceptability status definition block of FIG. 5.

### DETAILED DESCRIPTION OF THE PREFERRED EMBODIMENT

The following description of the preferred embodiment is merely exemplary in nature and is in no way intended to limit the invention, its application, or uses.

Real-time process control is generally implemented to control the fuel cell power system described herein. In this regard, real-time computer processing is broadly defined as a method of processing in which an event causes a given reaction within an actual time limit and wherein actions are specifically controlled within the context of and by external conditions and actual times. As an associated clarification in the realm of process control, real-time controlled processing relates to the performance of associated process control logical, decision, and quantitative operations intrinsic to a process control decision algorithm functioning as part of a controlled apparatus implementing a process (such as the fuel cell benefiting from the present invention) wherein the process control decision algorithm is periodically executed with fairly high frequency usually having a period of between 20 ms and 2 sec for tactical control.

Many control decisions in operation of a fuel cell power system depend on accurate measurement of fuel cell stack electrical current. Undetected electrical current sensor drift in a fuel cell power system can lead to costly stresses on the fuel cell. For example, an electrical current reading which is inappropriately low respective to verity can be the basis of manipulation of cell control elements to the point were damaging cell reversal is derived from inappropriate “starvation” of the reactant feed gases. Fuel cell shutdown is also stressful to the fuel cell, and unnecessary shutdowns due to electrical current sensor drift and/or failure shorten thereby the maintenance life of the fuel cell.

To manage the above concerns in the preferred embodiment, a real-time computer operating the fuel cell is programmed to detect untrustworthy electrical current sensors. The executed logic within the real-time computer compares, for a set of electrical current sensors redundantly measuring the same electrical current, the measurement of each electrical current sensor in operation with the measurements from every other electrical current sensor in operation to see if the measured values agree within a specified tolerance level. In normal operation, each electrical current sensor therefore has a number of other electrical current sensors with which its reading “agrees.” The number of “agreements” associated with each electrical current sensor is compared with the “agreements” of the other electrical current sensors using combinational logic (as executed in the real-time computer) to determine if each individual electrical current sensor has either a trustworthy or an untrustworthy acceptability status. The trustworthy electrical current sensors are then averaged to determine a characteristic fuel cell stack system electrical current measurement. Untrustworthy electrical current sensors are excluded from use in the characteristic electrical current measurement calculation. An untrustworthy electrical current sensor may also be indicated by command or visually. Since the untrustworthy electrical current sensor is effectively “removed” from the control decision process in the fuel cell, the fuel cell power system continues to operate without shutdown. If untrustworthy electrical current sensor warnings are ignored until a significant subset of the set of all electrical current sensors are considered untrustworthy, the appropriate shutdown or transfer of operational state to a safe operation mode is ultimately implemented by the control system.

The invention is further understood with reference to a generic fuel cell power system. Therefore, before further describing the invention, a general overview of the power system within which the improved fuel cells of the invention operate is provided. In one embodiment, a hydrocarbon fuel is processed in a fuel processor, for example, by reformation and partial oxidation processes, to produce a reformate gas which has a relatively high hydrogen content on a volume or molar basis. Therefore, reference is made to hydrogen-containing as having relatively high hydrogen content. The invention is hereafter described in the context of a fuel cell fueled by an H₂-containing reformate regardless of the method by which such reformate is made. It is to be understood that the principles embodied herein are applicable to fuel cells fueled by H₂ obtained from any source, including reformable hydrocarbon and hydrogen-containing fuels such as methanol, ethanol, gasoline, alkaline, or other aliphatic or aromatic hydrocarbons.

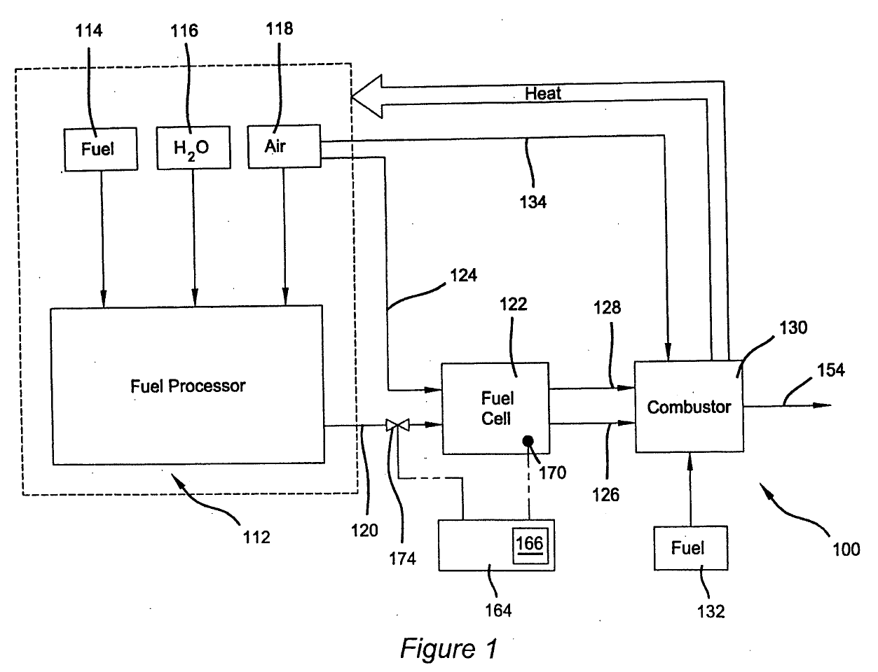

As shown in FIG. 1, a fuel cell power system 100 includes a fuel processor 112 for catalytically reacting a reformable hydrocarbon fuel stream 114, and water in the form of steam from a water stream 116. In some fuel processors, air is also used in a combination partial oxidation/steam reforming reaction. In this case, fuel processor 112 also receives an air stream 118. The fuel processor 112 contains one or more reactors wherein the reformable hydrocarbon fuel in stream 114 undergoes dissociation in the presence of steam in stream 116 and air in stream 118 to produce the hydrogen-containing reformate exhausted from fuel processor 112 in reformate stream 120. Fuel processor 112 typically also includes one or more downstream reactors, such as water-gas shift (WGS) and/or preferential oxidizer (PrOx) reactors that are used to reduce the level of carbon monoxide in reformate stream 120 to acceptable levels, for example, below 20 ppm. H₂-containing reformate 120 is fed through block valve 174 (one control element manipulated by real-time computer 164 to control fuel cell stack system 122) into the anode chamber of fuel cell stack system 122. Concurrent with the feeding of H₂-containing reformate 120 through block valve 174 into the anode chamber of fuel cell stack system 122, oxygen in the form of air in stream 124 is fed into the cathode chamber of fuel cell stack system 122. The hydrogen from reformate stream 120 and the oxygen from oxidant stream 124 react in fuel cell stack system 122 to produce electricity.

Anode exhaust (or effluent) 126 from the anode side of fuel cell stack system 122 contains some unreacted hydrogen. Cathode exhaust (or effluent) 128 from the cathode side of fuel cell stack system 122 may contain some unreacted oxygen. These unreacted gases represent additional energy recovered in combustor 130, in the form of thermal energy, for various heat requirements within power system 100. Specifically, a hydrocarbon fuel 132 and/or anode effluent 126 are combusted, catalytically or thermally, in combustor 130 with oxygen provided to combustor 130 either from air in stream 134 and/or from cathode effluent stream 128, depending on power system 100 operating conditions. Combustor 130 discharges exhaust stream 154 to the environment, and the heat generated thereby is directed to fuel processor 112 as needed.

Real-time computer 164 effects control of valve 174 in response to a signal from (at least) electrical current sensors 170. For clarity current sensor 170 is shown in singular in FIG. 1; however, as further described herein, current sensor may represent a plurality of current sensors associated with the fuel cell stack 122. Specifically, the hydrogen feed to fuel cell stack system 122 is controlled in part through manipulation of block valve 174 by real-time computer 164 with respect to electrical current measurements from electrical current sensor 170 in enabling hydrogen-containing gas to flow to fuel cell stack system 122. In a preferred embodiment, electrical current sensor(s) 170 are Hall-effect electrical current sensors. Controller logic 166 is provided in real-time computer 164 for execution in real-time by computer 164. In this regard, controller logic 166 is also denoted as “software” and/or a “program” and/or an “executable program” within real-time computer 164 as a data schema holding data and/or formulae information and/or program execution instructions which constitutes a process algorithm. Controller logic 166 is, in a preferred embodiment, machine code resident in the physical memory storage (e.g., “RAM” “ROM” or on a disk) of computer 164. Controller logic 166 is preferably derived from a source language program compiled to generate the machine code. The physical memory storage is in electronic data communication with a central processing unit (CPU) of computer 164 which reads data from the physical memory, computationally modifies read data into resultant data, and writes the resultant data to the physical memory. Computer 164 also receives control signals from sensor(s) 170 and sends control signals to valve 174 according to the provisions of controller logic 166.

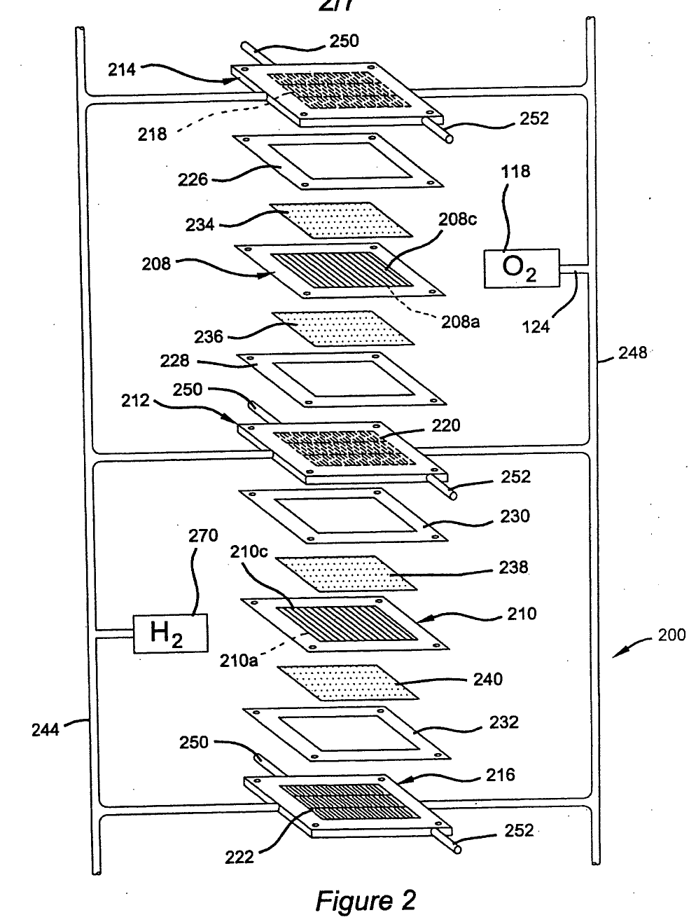

Turning now to FIG. 2, a partial PEM fuel cell stack 200 of fuel cell stack system 122 is schematically depicted as having a pair of membrane electrode assemblies (MEAs) 208 and 210 separated from each other by a non-porous, electrically-conductive plate 212. Each of MEAs 208, 210 have a cathode face 208c, 210c and an anode face 208a, 210a. MEAs 208, 210 and bipolar plate 212 are stacked together between non-porous, electrically-conductive, liquid-cooled plates 212, 214 and 216. Plates 212, 214, 216 each include respective flow fields 218, 220, 222 established from a plurality of flow channels formed in the faces of the plates for distributing fuel and oxidant gases (i.e., H₂ & O₂) to the reactive faces of MEAs 208, 210. Nonconductive gaskets or seals 226, 228, 230, 232 provide sealing and electrical insulation between the several plates of fuel cell stack 200. It is to be noted that fuel cell stack 200 shows two fuel cells with plate 212 being shared between the two fuel cells and plates 214, 216 being shared between one of the shown fuel cells and, in each case, another fuel cell not depicted in FIG. 2. In this regard, a “fuel cell” within a fuel cell stack is not physically fully separable insofar as any particular fuel cell in the stack will share at least one side of a bipolar plate with another cell.

Porous, gas permeable, electrically conductive sheets 234, 236, 238, 240 press up against the electrode faces of MEAs 208, 210 and serve as primary electrical current collectors for the respective electrodes. Primary electrical current collectors 234, 236, 238, 240 also provide mechanical supports for MEAs 208, 210, especially at locations where the MEAs are otherwise unsupported in the flow field. Plate 214 presses up against primary electrical current collector 234 on cathode face 208c of MEA 208, plate 216 presses up against primary electrical current collector 240 on anode face 210a of MEA 210, and plate 212 presses up against primary electrical current collector 236 on anode face 208a of MEA 208 and against primary electrical current collector 238 on cathode face 210c of MEA 210.

An oxidant gas such as air/oxygen is supplied to the cathode side of fuel cell stack 200 from air source 118 and line 124 via appropriate supply plumbing 248. A fuel such as hydrogen is supplied to the anode side of fuel cell 200 from a hydrogen source 270 via appropriate supply plumbing 244. Exhaust plumbing (not shown) for both the H₂ and O₂/air sides of MEAs 208, 210 is also provided for removing anode effluent from the anode flow field and the cathode effluent from the cathode flow field. Coolant plumbing 250, 252 is provided for supplying and exhausting liquid coolant to bipolar plates 212, 214, and 216, as needed.

Turning now to further detail in controller logic 166 of real-time computer 164, generic fuel cell power system 100 (see FIG. 1) uses block valve 174 to control hydrogen gas flow, and electrical current sensor(s) 170 are used as a feedback sensors measuring electricity generated by stack 200. Along with other feedback loops and control decisions (not shown), computer-implemented determination of electrical current sensor acceptability is effected in controller logic 166 as part of the control decision process implementing control between electrical current sensor(s) 170 and valve 174.

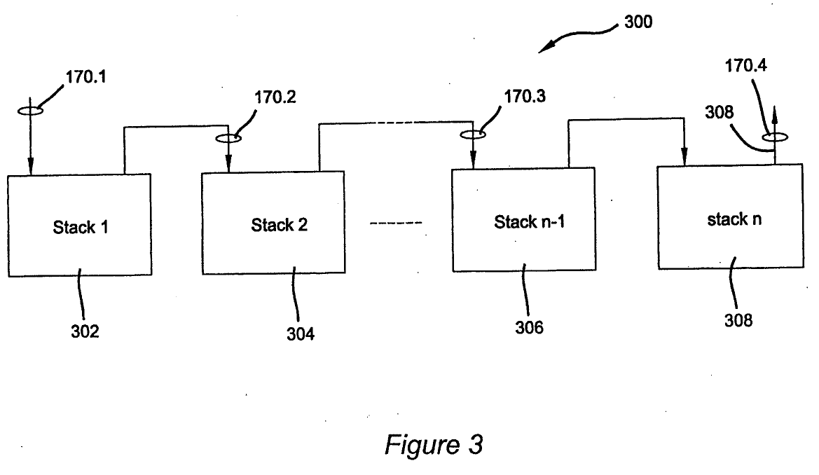

Turning now to FIG. 3, a series of fuel cell stacks 300 of fuel cell stack system 122 are shown in connection as a (voltage and resistance)? electrical series. Electrical current in conductor 310 is derived from the current generated individual cells within the stacks. Conductor 310 electrical current is measured by electrical current sensors 170.1, 170.2, 170.3, 170.4 (reprised as sensor 170 in FIG. 1) where fuel cell stack 302, fuel cell stack 304, fuel cell stack 306 and fuel cell stack 308 are implemented in an electrical (voltage and resistance) series as shown with one electrical current sensor provided for each stack. Fuel stack set 300 uses fuel cell stacks 302, 304, 306, and 308 as a plurality of fuel cell stacks in the set of n fuel cell stacks. Stacks 302, 304, 306, 308 may be separate and distinct modules or alternatively may be separate and distinct clusters of cells within a stack.

Use of multiple current sensors to confirm an electrical current measurement in fuel cell power system operation is not confined to fuel cell stack series arrangements. One embodiment uses a multiple set of electrical current sensors to redundantly measure the electrical current generated from a single standalone fuel cell stack. Another embodiment uses a multiple set of electrical current sensors to redundantly measure the electrical current generated from a single fuel cell. A set of fuel cell stacks 300 is, in one embodiment, provided for the power plant for a bus, such as, without limitation, a school bus, a tour bus, or a metropolitan transit passenger bus. In another embodiment, a set of fuel cell stacks 300 is provided for the power plant for an automobile. In yet another embodiment, a set of fuel cell stacks 300 is provided for a stationary power generation application.

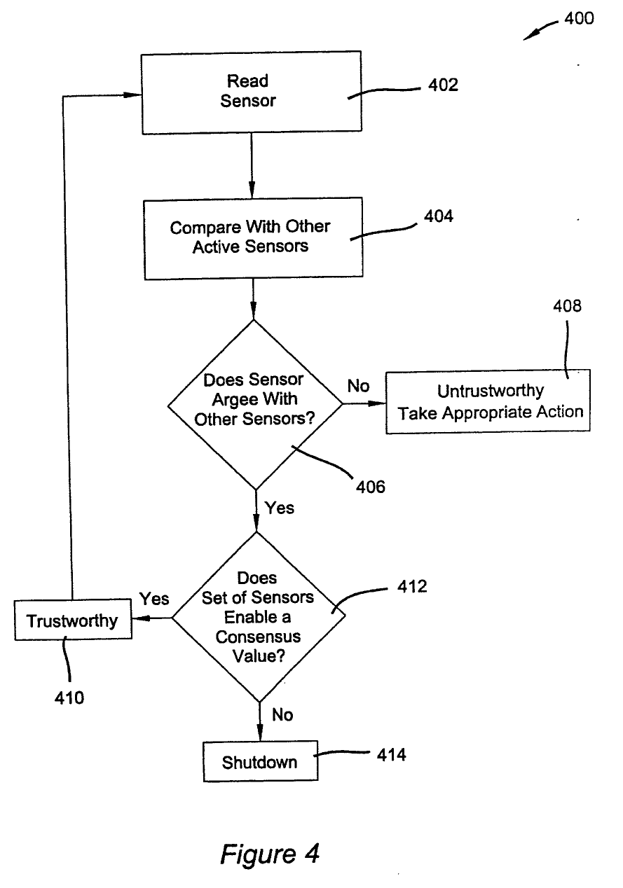

Computer-implemented determination of electrical current sensor acceptability is effected in controller logic 166 for a particular signal input into computer 164 from any of electrical current sensors 170.1, 170.2, 170.3, 170.4 according to the algorithm 400 of FIG. 4. Block 402 of FIG. 4 represents the reading of the electrical current sensor data from an electrical current sensor such as sensors 170.1, 170.2, 170.3, 170.4. Block 404 shows a comparison operation, followed by decision block 406 for designating (a) an untrustworthy acceptability status (block 408) or (b) further action in decision block 412. Decision block 412 evaluates other considerations in the status of all electrical current sensors as a set to lead to either a trustworthy designation for the particular electrical current sensor (e.g., any of electrical current sensors 170.1, 170.2, 170.3, 170.4) in block 410 or to a shutdown decision in block 414.

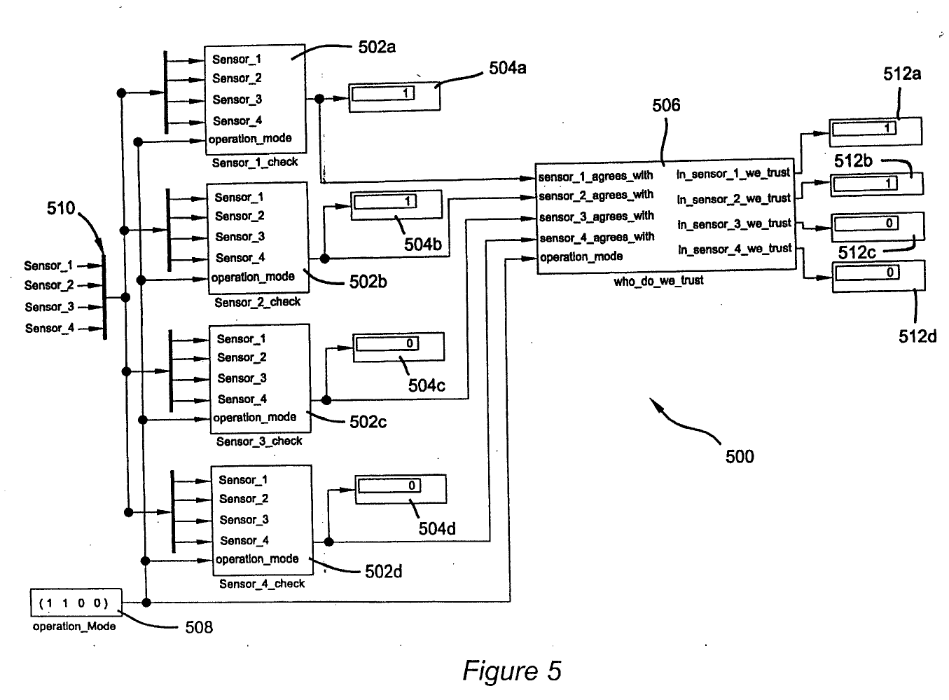

FIG. 5 shows the acceptability status definition method 500 for a set of electrical current sensors. In this regard, FIGS. 5-7 show a (simulated) block flow characterization of the “executable program” within real-time computer 164 as a portion of controller logic 166 and the algorithm 400 illustrated in FIG. 4.

FIG. 5 shows an exemplary logic flow for 4 different sensors, designated as 170.1, 170.2, 170.3 and 170.4 respectively in FIG. 3. Sensor_1, sensor_2, sensor_3, and sensor_4 represent data values from sensors 170.1,170.2, 170.3, 170.4 which are independently addressed via multiplexing logic 510 into agreement logical blocks 502a, 502b, 502c, and 502d. Agreement logical blocks 502a, 502b, 502c, and 502d independently evaluate sensor_1 sensor_2, sensor_3, and sensor_4 respectively such that, for example, agreement logical block 502a independently compares the value of the measurement of electrical current sensor sensor_1 to the individual values of the measurements of each of the other electrical current sensors (sensor_2, sensor_3, and sensor_4) in the set of electrical current sensors. In a similar manner, agreement logical block 502b, 502c and 502d independently compares the data value of sensor_2, sensor_3 and sensor_4, respectively to the individual data values of the other electrical current sensors. In some fuel cell systems with multiple stacks implemented in electrical series it is sometimes desirable to electrically remove a stack from the fuel cell system, therefore in implementing the agreement logical block 502 decision, an operation mode variable for designating inactive stacks and their corresponding invalid electrical current sensors is read from operation mode variable block 508. In the example within FIG. 5, for instance, stack_1 with corresponding sensor_1 and stack_2 with corresponding sensor_2 are “on-line” (operation mode variable value of “1”) with stack_3 with corresponding sensor_3 and stack_4 with corresponding sensor_4 being “off-line” (operation mode variable value of “0”). In the case where one electrical current sensor is provided for each fuel cell stack (see FIG. 3), operation mode indicators indicate the state of a given fuel cell stacks, wherein stack 302, 304 are “on-line” and stacks 306, 308 are “off-line”. Since the operation mode shows that stacks 306, 308 are off-line, the outputs of their corresponding agreement logical blocks (502c and 502d) determine that their sensors are also off-line and are to be excluded from the agreement logic block 508. Acceptability status definition block 506 takes these factors into consideration and determines whether sensor one and two are trustworthy, as indicated by the corresponding outputs of “1” (see display blocks per 512).

Acceptability status definition block 506 receives output from agreement logical blocks 502a, 502b, 502c, and 502d as well as output from operation mode variable block 508 to effect definition of trusted electrical current sensors.

Display blocks 504 and 512 show the status of particular decision operations within acceptability status definition method 500. These values mirror the output of the diagnostic logic embedded within controller logic 166 in data communication with the comparison logic. In this regard, display blocks 504 and 512 affect diagnostic communication of the acceptability status of each electrical current sensor. In a preferred embodiment, display block 512 is a visual indicator such as a warning message when the acceptability status for each electrical current sensor respective to the comparison and diagnostic decision processes indicates an untrustworthy sensor and is displayed through a message enunciator.

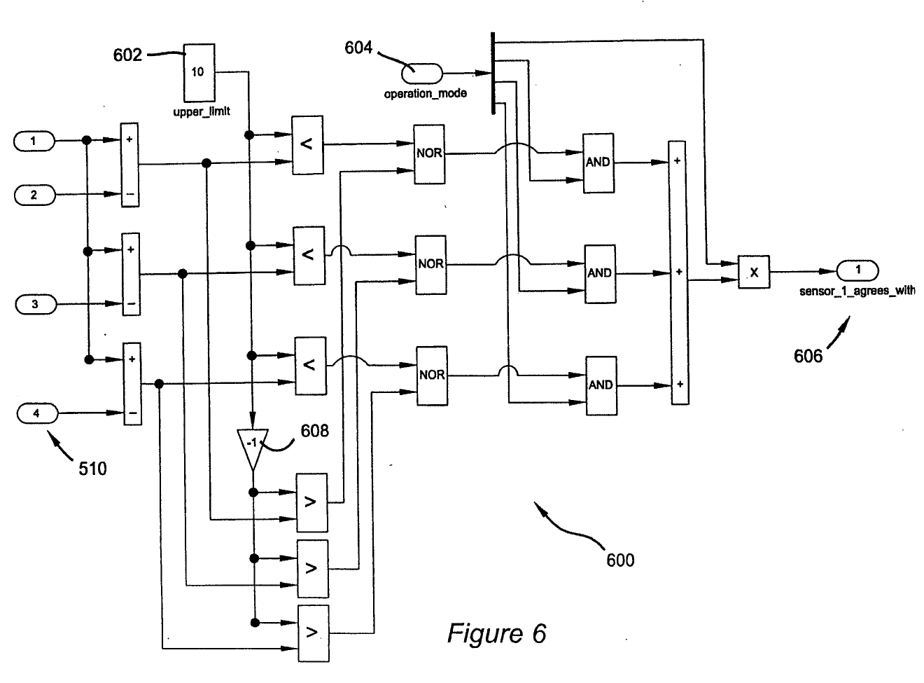

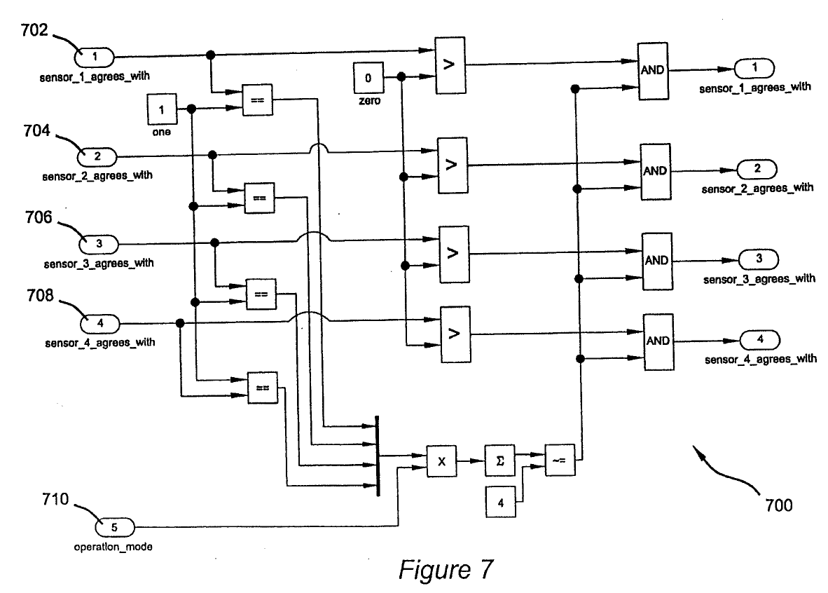

FIGS. 6 and 7 present further detail in the comparison logic within controller logic 166 and also in the diagnostic logic embedded in data communication with the comparison logic.

FIG. 6 shows detail 600 of agreement logical block 502 shown in FIG. 5. Inputs from multiplexing logic 510 (FIG. 5) are reprised from FIG. 5. Output as displayed in block 504 (FIG. 5) for input into block 506 is shown at 606. Operation mode (block 508) is brought forward into FIG. 6 in data linkage 604. FIG. 6 also shows threshold tolerance variable 602 (with an exemplary value of 10) so that the acceptability status of block 502 is defined by comparison of the difference of two independent electrical current sensor values to tolerance variable 602 (in this case as a fixed value of 10). The “upper limit” tolerance value is multiplied by −1 in inverter 608 to create a companion “lower limit” tolerance value. Thus, a threshold range is defined by the upper and lower tolerance limits. A skilled practitioner will recognize that the upper and lower limits, and thus the threshold range will vary depending on the particular application and the operating condition of the system for such applications.

FIG. 7 shows detail 700 in acceptability status definition block 506 as shown in FIG. 5. Inputs 702, 704, 706, 708 and 710 are top-to-bottom inputs into block 506 from blocks 502a, 502b, 502c, 502d, and 508 shown in FIG. 5 respectively. As data for each individual sensor is processed through block 506, a decision on trustworthiness or untrustworthiness is defined. Table 1 below presents a number of different value sets for sensor_1, sensor_2, sensor_3, and sensor_4, with affiliated indications of trustworthy or untrustworthy acceptability status when processed via the executable logic depicted in FIGS. 4-7.

TABLE 1

| | 1 | | | 2 | | | 3 | | |
|---|---|---|---|---|---|---|---|---|---|
| Test No | 510 | 502 | trust? | 510 | 502 | trust? | 510 | 502 | trust? |
| Sensor | value | value | (512) | value | value | (512) | value | value | (512) |
| sensor_1 | 180 | 0 | No | 100 | 2 | Yes | 100 | 3 | Yes |
| sensor_2 | 101 | 1 | Yes | 101 | 2 | Yes | 101 | 3 | Yes |
| sensor_3 | 100 | 1 | Yes | 150 | 0 | No | 100 | 3 | Yes |
| sensor_4 | 160 | 0 | No | 99 | 2 | Yes | 99 | 3 | Yes |
| | 4 | | | 5 | | | 6 | | |
| Test No | 510 | 502 | trust? | 510 | 502 | trust? | 510 | 502 | trust? |
| Sensor | value | value | (512) | value | value | (512) | value | value | (512) |
| sensor_1 | 180 | 0 | No | 180 | 0 | No | 180 | 1 | No |
| sensor_2 | 101 | 1 | Yes | 101 | 0 | No | 101 | 1 | No |
| sensor_3 | 100 | 1 | Yes | 120 | 0 | No | 100 | 1 | No |
| sensor_4 | 79 | 0 | No | 79 | 0 | No | 179 | 1 | No |

Test No. 1, 4 and 5 of Table 1 show two bad sensors but do not define a shutdown scenario, preserving robust operation of the fuel cell system in the face of sensor failure. However, Test No. 6 of Table 1 defines a basis for a shutdown decision for lack of trust in any sensor with only two bad sensors based on the operation mode of the system. In other words, two sets of sensors are in agreement; however, there is not enough information to say which two to trust. In this regard, certain patterns of acceptability status values patterned as a first defined set denote acceptable continued operation and other patterns of acceptability status values patterned as a second defined set denote a need to shutdown. The described embodiment therefore enables shutdown when an effectively predefined collective shutdown value set is equivalent to all the acceptability status values patterned as a comparably defined set.

After definition of either trustworthy or untrustworthy acceptability status for each of electrical current sensors 170 a characteristic current measurement from all electrical current sensors having a trustworthy acceptability status is calculated. In a preferred embodiment, the characteristic current measurement is an average value of all electrical current sensors 170 having a trustworthy acceptability status. Control logic 166 effects manipulation (adjustment) of control elements of the fuel cell (such as valve 174) with respect to the characteristic electrical current measurement value.

The description of the invention is merely exemplary in nature and, thus, variations that do not depart from the gist of the invention are intended to be within the scope of the invention. Such variations are not to be regarded as a departure from the spirit and scope of the invention.

1. A fuel cell system generating electrical current comprising:
a plurality of electrical current sensors connected to a fuel cell element to independently measure electrical current generated by said fuel cell element; and
a current monitoring device connected to each electrical current sensor; said current monitoring device having comparison logic defining an acceptability status selected from the group consisting of trustworthy and untrustworthy for each of said plurality of electrical current sensor by independent comparison of a data value generated by said electrical current sensor to data values generated by the other of said electrical current sensors in said plurality of electrical current sensors.

2. The fuel cell of claim 1 wherein said comparison logic further comprises tolerance variable so that said acceptability status for each of said plurality of electrical current sensors is defined by comparison of the difference of two independent electrical current sensor values to said tolerance variable.

3. The fuel cell of claim 2 wherein said tolerance variable defines a threshold range.

4. The fuel cell of claim 2 wherein said tolerance variable has a fixed value.

5. The fuel cell of claim 1 wherein said comparison logic further comprises an operation mode variable for excluding data values for a given electrical current sensor in said fuel cell.

6. The fuel cell of claim 1 wherein a plurality of fuel cell elements are deployed in a set of fuel cell stacks, each of said set of fuel cell stacks having at least one electrical current sensor comprising said plurality of electrical current sensors.

7. The fuel cell of claim 6 wherein each stack has one electrical current sensor.

8. The fuel cell of claim 1 wherein said comparison logic derives a characteristic current measurement from all electrical current sensors having an acceptability status which is trustworthy.

9. The fuel cell of claim 8 wherein said characteristic current measurement is an average value of all said electrical current sensors having an acceptability status which is trustworthy.

10. The fuel cell of claim 8 wherein said current monitoring device further comprises control logic in data communication with said characteristic current measurement, said control logic effecting manipulation of a control element of said fuel cell.

11. The fuel cell of claim 1 wherein said current monitoring device further comprises diagnostic logic in data communication with said comparison logic, said diagnostic logic effecting a diagnostic communication indicating said acceptability status of each of said plurality of electrical current sensors.

12. The fuel cell of claim 11 further comprising a visual indicator for each of said plurality of electrical current sensor, said visual indicator in electrical communication with said measurement device, said diagnostic logic having an acceptability status variable specific to said electrical current sensor and to said visual indicator for holding said acceptability status of each of said plurality of electrical current sensors, wherein said acceptability status for each of such plurality of electrical current sensors is shown in an active state of its respective visual indicator.

13. The fuel cell of claim 11 wherein said current monitoring device further comprising shutdown logic in data communication with each of said acceptability status variables, said shutdown logic effecting manipulation of a dynamic control element of said fuel cell to halt operation of said fuel cell when at least one predefined collective shutdown value set is equivalent to all said acceptability status values patterned as a comparably defined set.

14. A method for operating a fuel cell to generate electrical current comprising:
measuring electrical current generated by a fuel cell element with a plurality of electrical current sensors;
defining an acceptability status selected from the group consisting of trustworthy and untrustworthy for each of said electrical current sensors by independent comparison of a data value of each electrical current sensor to data values of the other electrical current sensors in said plurality of electrical current sensors; and
operating said fuel cell using measurements from each of said plurality of electrical current sensors defined to have a trustworthy acceptability status.

15. The method of claim 14 wherein defining an acceptability status uses a tolerance variable so that each of said acceptability status is defined by comparison of the difference of two independent electrical current sensor values to said tolerance variable.

16. The method of claim 15 wherein said tolerance variable defines a threshold range.

17. The method of claim 15 wherein said tolerance variable has a fixed value.

18. The method of claim 14 further comprises designating an operation mode variable for excluding data values for a given electrical current sensor in said fuel cell.

19. The method of claim 14 further comprising measuring electrical current generated by a plurality of fuel cell elements deployed in a set of fuel cell stacks, each of said set of fuel cell stacks having at least one said electrical current sensor of said plurality of electrical current sensors.

20. The method of claim 18 wherein each stack has one electrical current sensor.

21. The method of claim 20 further comprising deriving a characteristic current measurement from all of said electrical current sensors having an acceptability status which is trustworthy.

22. The method of claim 21 further comprising averaging all of said electrical current sensors having an acceptability status which is trustworthy to derive said characteristic current measurement.

23. The method of claim 19 further comprising operating said fuel cell using said characteristic current measurement to effect manipulation of a control element of said fuel cell.

24. The method of claim 14 further comprising determining diagnostic information for said plurality of electrical current sensors and affecting a diagnostic communication indicating the acceptability status of each of said electrical current sensors.

25. The method of claim 24 further comprising activating a visual indicator for each of said electrical current sensors having an acceptability status which is determined to be untrustworthy.

26. The method of claim 25 further comprising halting operation of said fuel cell when at least one predefined collective shutdown value set is equivalent to all of said acceptability status values patterned as a comparably defined set.
